(19) United States
(12) Patent Application Publication
(10) Pub. No.: US 2019/0178206 A1
(43) Pub. Date: Jun. 13, 2019

(54) JET ENGINE COMPRISING A NACELLE EQUIPPED WITH A THRUST REVERSING SYSTEM COMPRISING DOORS

(71) Applicant: Airbus Operations SAS, Toulouse (FR)

(72) Inventors: Frédéric RIDRAY, L'ISLE JOURDAIN (FR); Lionel CZAPLA, CORNEBARRIEU (FR); Frédéric PIARD, TOURNEFEUILLE (FR)

(21) Appl. No.: 16/209,413

(22) Filed: Dec. 4, 2018

(30) Foreign Application Priority Data
Dec. 8, 2017 (FR) 1761820

(51) Int. Cl. F02K 1/76; F02K 1/62

(52) U.S. Cl. CPC F02K 1/763; B64D 29/06; F02K 1/62

(57) ABSTRACT

A engine comprising a fan casing and a nacelle, the nacelle comprising a fixed structure and a thrust reversing system having a mobile assembly with a mobile cowl and a frame. The mobile assembly is translationally mobile on the fixed structure between an advanced position and a retracted position to define a window between the secondary jet and the outside of the nacelle. Inner and outer doors are mounted articulated between a stowed position and a deployed position. For each pair of doors, a runner is translationally mobile between a first and a second position. The switching from the stowed position to the deployed position of each door is mechanically associated with the switching of the runner from the first position to the second position and vice versa. For each runner, an actuator ensures the translational displacement of the runner from the first position to the second position.

### CROSS-REFERENCES TO RELATED APPLICATIONS

This application claims the benefit of the French patent application No. 1761820 filed on Dec. 8, 2017, the entire disclosures of which are incorporated herein by way of reference.

### FIELD OF THE INVENTION

The present invention relates to a dual flow jet engine which comprises a nacelle equipped with a thrust reversing system comprising doors, an aircraft comprising at least one such dual flow jet engine, and a method for displacing the thrust reversing system in such a dual flow jet engine.

### BACKGROUND OF THE INVENTION

An aircraft comprises a fuselage, on each side of which is fixed a wing. Under each wing, there is suspended at least one dual flow jet engine with a secondary jet. Each dual flow jet engine is fixed under the wing via a pylon which is fixed between the structure of the wing and the structure of the dual flow jet engine.

The dual flow jet engine comprises an engine and a nacelle which is fixed around the engine.

The nacelle comprises a thrust reversing system which comprises a plurality of outer doors, each being rotationally mobile on the structure of the nacelle between a stowed position in which it comes into continuity with the outer surface of the nacelle and an outward deployed position in which it opens a window in the wall of the nacelle to expel the air of the secondary flow to the outside of the nacelle.

Some thrust reversing systems also include inner doors, in which each is mobile between a stowed position in which it is pressed against an inner surface of the nacelle around the secondary jet, and a deployed position in which it is positioned across the secondary jet to direct the secondary flow towards the window.

Currently, the displacement of the inner and outer doors requires a relatively complex maneuvering system and it is necessary to find a different mechanism.

### SUMMARY OF THE INVENTION

One object of the present invention is to propose a dual flow jet engine which comprises a nacelle equipped with a thrust reversing system with a plurality of doors and with a different opening/closing mechanism.

To this end, a dual flow jet engine is proposed comprising an engine, a nacelle surrounding the engine and a fan casing, in which a secondary jet of a secondary flow is delimited between the nacelle and the engine and in which an air flow circulates in a direction of flow, the nacelle comprising:
a fixed structure attached to the fan casing,
a thrust reversing system having:
a mobile assembly having a mobile cowl and a frame, the mobile cowl being fixed to and downstream of the frame relative to the direction of flow, the mobile assembly being translationally mobile on the fixed structure in a direction of translation between an advanced position in which the mobile assembly is positioned in such a way that the mobile cowl is close to the fan casing and a retracted position in which the mobile assembly is positioned in such a way that the mobile cowl is at a distance from the fan casing to define between them an open window between the secondary jet and the outside of the nacelle,
a plurality of pairs of doors arranged inside the nacelle, each pair being formed by an inner door and an outer door arranged facing the inner door, each door being mounted articulated by a downstream edge, relative to the direction of flow, on the frame between a stowed position in which it blocks a zone of the window and a deployed position in which it does not block the zone of the window, the inner doors extending towards the engine in a deployed position, the outer doors extending outwards from the nacelle in the deployed position and being arranged between the mobile cowl and the fixed structure in the stowed position so as to form an outer wall of the nacelle,
for each pair of doors, a runner associated with the pair of doors, the runner being mounted to be translationally mobile parallel to the direction of translation on the frame between a first position and a second position, in which the switching from the stowed position to the deployed position of each door of the pair is mechanically associated with the switching of the runner from the first position to the second position and vice versa, and
for each runner, a second actuator provided to ensure the translational displacement of the runner from the first position to the second position and vice versa, and
at least one first actuator provided to ensure the translational displacement of the frame from the advanced position to the retracted position and vice versa.

Such a jet engine makes it possible to simplify the mechanism actuating the thrust reversing system and to dissociate the displacement of the mobile assembly from the displacement of the doors.

Advantageously, the thrust reversing system further comprises, for each runner, a first transmission system provided to switch the inner door associated with the runner from the stowed position to the deployed position simultaneously with the switching of the runner from the first position to the second position and vice versa, and, for each runner, a second transmission system provided to switch the outer door associated with the runner from the stowed position to the deployed position simultaneously with the switching of the runner from the first position to the second position and vice versa.

Advantageously, each actuator takes the form of an electric ball jack.

Advantageously, the nacelle comprises at least one baffle plate arranged around the secondary jet at the entry of the window.

The invention also proposes an aircraft comprising at least one dual flow jet engine according to one of the preceding variants.

The invention also proposes a displacement method for a thrust reversing system according to one of the preceding variants and comprising, from the advanced position of the mobile assembly, from the stowed positions of the inner and outer doors, from the first position of the runners:
a first activation step during which each first actuator is activated to ensure the translational displacement of the mobile assembly from the advanced position to the retracted position, then
a second activation step during which each second actuator is activated to ensure the translational displacement of the associated runner from the first position to the second position, then
a third activation step during which each second actuator is activated to ensure the translational displacement of the associated runner from the second position to the first position, then
a fourth activation step during which each first actuator is activated to ensure the translational displacement of the mobile assembly from the retracted position to the advanced position.

### BRIEF DESCRIPTION OF THE DRAWINGS

The features of the invention mentioned above, and others, will become more clearly apparent on reading the following description of an exemplary embodiment, the description being given in relation to the attached drawings, in which:

FIG. 1 is a side view of an aircraft comprising a dual flow jet engine according to the invention,

FIG. 2 is a perspective and interior view of a part of a nacelle of the dual flow jet engine according to the invention,

FIG. 3 is a schematic and cross-sectional representation of a thrust reversing system according to the invention in the stowed position,

FIG. 4 is a representation similar to that of FIG. 3 for an intermediate position,

FIG. 5 is a representation similar to that of FIG. 3 for a deployed position,

FIG. 6 shows an outside view of the thrust reversing system, and

FIG. 7 represents a functional diagram of a displacement method for a thrust reversing system according to the invention.

### DETAILED EXPLANATION OF EMBODIMENTS

In the following description, the terms relating to a position are taken with reference to the direction of flow of the air in a jet engine which therefore flows from forward to aft of the aircraft while the aircraft is moving forwards.

FIG. 1 shows an aircraft 10 which comprises a fuselage 12, on each side of which is fixed a wing 14 which bears at least one dual flow jet engine 100 according to the invention. The dual flow jet engine 100 is fixed under the wing 14 via a pylon 16.

The dual flow jet engine 100 has a nacelle 102, an engine which is housed inside the nacelle 102 in the form of a core and a fan casing 206a forward of the nacelle 102.

In the following description, and by convention, X denotes the longitudinal axis of the dual flow jet engine 100 which is parallel to the longitudinal axis of the aircraft 10, or roll axis, oriented positively towards the front of the aircraft 10, Y denotes the transverse axis which is parallel to the pitch axis of the aircraft which is horizontal when the aircraft is on the ground, and Z denotes the vertical axis which is parallel to the yaw axis when the aircraft is on the ground, these three directions X, Y and Z being mutually orthogonal and forming an orthonormal reference frame.

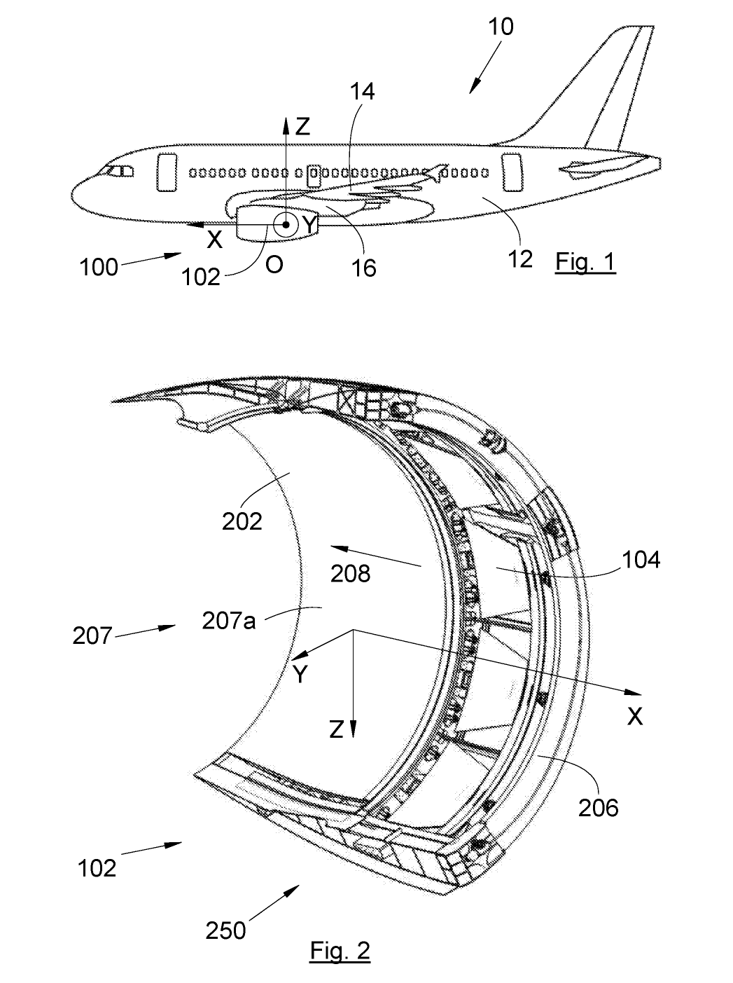

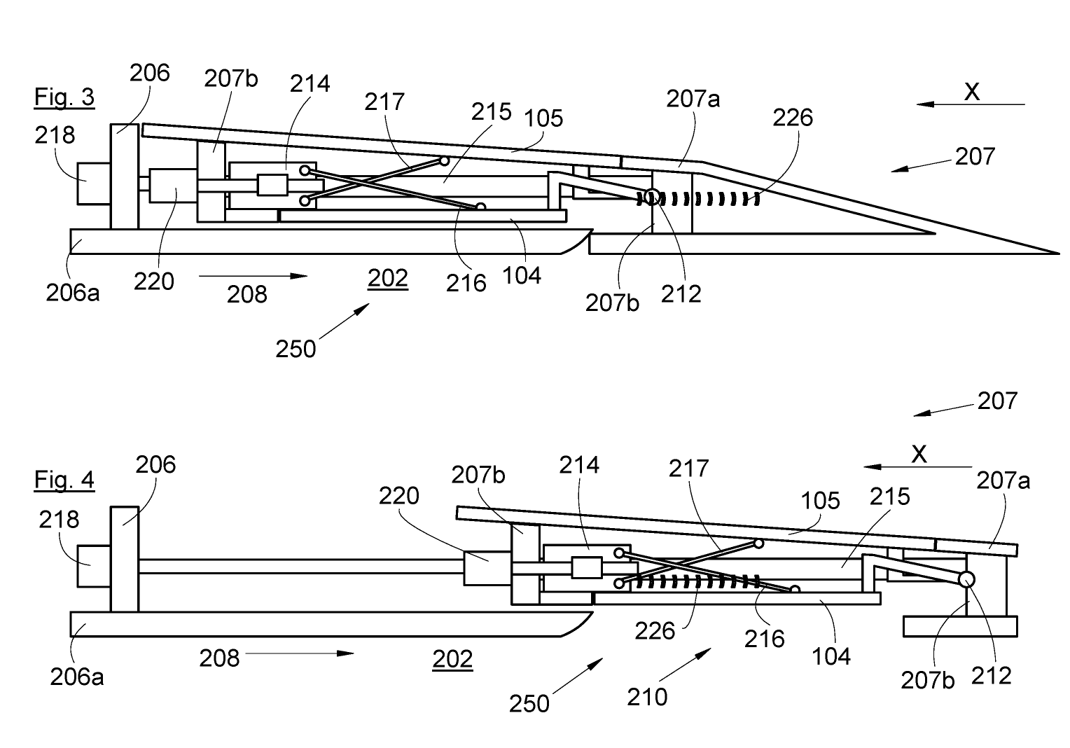

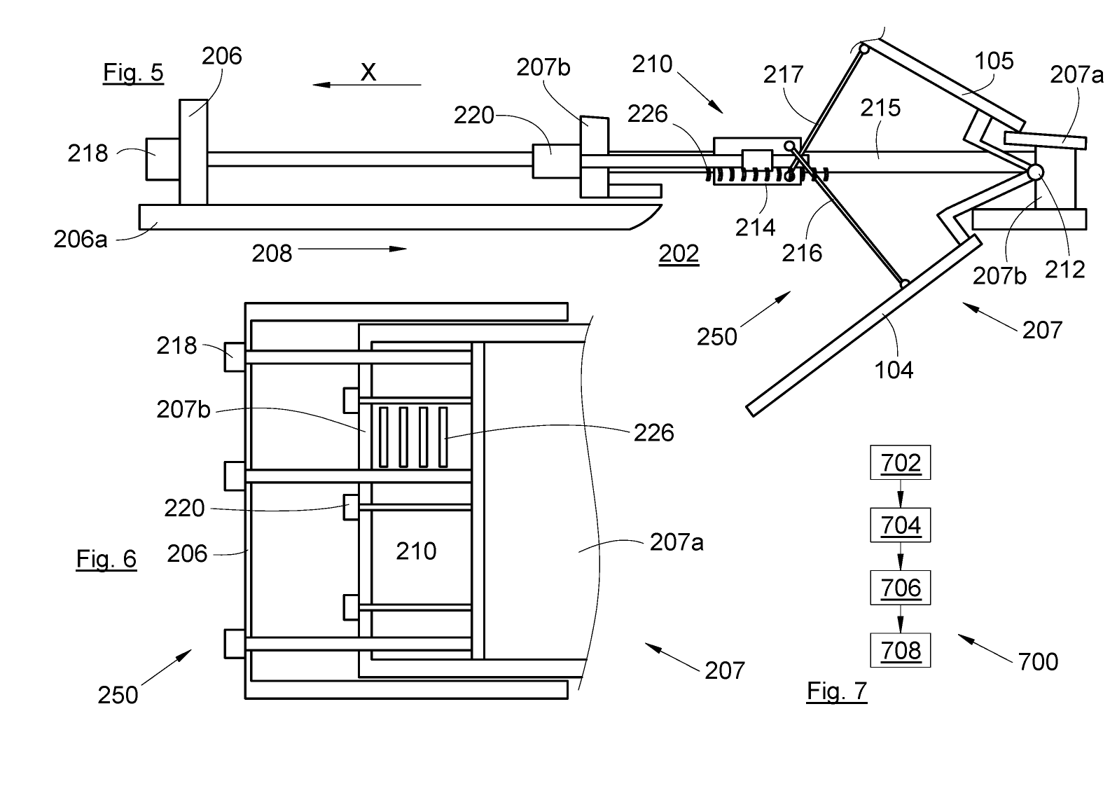

FIG. 2 shows a part of the nacelle 102 and FIGS. 3 to 5 show different positions of a thrust reversing system 250 of the nacelle 102. FIG. 6 shows an outside view of the thrust reversing system 250 in the deployed position, but without the doors of the thrust reversing system 250.

The dual flow jet engine 100 has, between the nacelle 102 and the engine, a secondary jet 202 in which the secondary flow 208 circulates originating from the air inlet through the fan and which therefore flows in the direction of flow which goes from upstream to downstream.

The nacelle 102 has a fixed structure 206 which is mounted fixed on the fan casing 206a.

The thrust reversing system 250 has a mobile assembly 207 which comprises a mobile cowl 207a forming the walls of the nozzle and a frame 207b. The frame 207b here takes the form of a cylinder with openwork walls. The mobile cowl 207a is fixed to and downstream of the frame 207b relative to the direction of flow.

The mobile assembly 207, via the frame 207b, is mounted to be translationally mobile in a direction of translation that is overall parallel to the longitudinal axis X on the fixed structure 206 of the nacelle 102, and more particularly here on the 12 o'clock beam and the 6 o'clock beam.

The translation of the frame 207b, and therefore of the mobile assembly 207, is produced by any appropriate guide systems such as, for example, guides between the fixed structure 206 and the frame 207b.

The mobile assembly 207, and therefore the frame 207b, is mobile between an advanced position (FIG. 3) and a retracted position (FIGS. 4, 5 and 6) and vice versa. In advanced position, the mobile assembly 207, and therefore the frame 207b, is positioned as far as possible forward relative to the direction of flow so that the mobile cowl 207a is close to the fan casing 206a. In retracted position, the mobile assembly 207, and therefore the frame 207b, is positioned as far aft as possible relative to the direction of flow so that the mobile cowl 207a is at a distance from the fan casing 206a.

In the advanced position, the mobile cowl 207a and the fan casing 206a are in continuation so as to define the outer surface of the secondary jet 202.

In the retracted position, the mobile cowl 207a and the fan casing 206a are at a distance and define between an open window 210 between the secondary jet 202 and the outside of the nacelle 102. That is to say that the air originating from the secondary flow 208 passes through the window 210 to re-emerge outside the dual flow jet engine 100.

The fan casing 206a delimits the window 210 upstream relative to the longitudinal axis X and the mobile cowl 207a delimits the window 210 downstream relative to the longitudinal axis X.

The nacelle 102 comprises a plurality of inner doors 104 distributed over the periphery and inside the nacelle 102 as a function of the angular aperture of the window 210 about the longitudinal axis X.

Each inner door 104 is mounted articulated on the frame 207b between a stowed position (FIGS. 3 and 4) and a deployed position (FIG. 5) and vice versa. The switching from the stowed position to the deployed position is performed by a rotation of the inner door 104 towards the inside of the jet engine 100.

The stowed position of the inner doors 104 can be adopted when the frame 207b is in advanced position or in retracted position. The deployed position of the inner doors 104 can be adopted only when the frame 207b is in retracted position.

In the stowed position, each inner door 104 blocks a zone of the openwork part of the frame 207b when the latter is in advanced position and the same zone of the openwork part of the frame 207b and a zone of the window 210 when the frame 207b is in the retracted position. In the deployed position, the inner door 104 does not block the zone of the window 210 or the openwork part of the frame 207b allowing passage of the secondary flow 208 and the inner door 104 extends towards the engine, that is to say across the secondary jet 202.

Thus, in the stowed position, each inner door 104 is overall in the extension of the mobile cowl 207a and in the deployed position, each inner door 104 is positioned across the secondary jet 202 and deflects at least a part of the secondary flow 208 to the outside through the window 210, the flow is oriented forwards using outer doors 105 that make it possible to produce a counter-thrust and that are described herein below.

In advanced position, each inner door 104 is positioned outside the fan casing 206a.

Each inner door 104 is articulated by a downstream edge, relative to the direction of flow, at the downstream part of the frame 207b on hinges 212 that are fixed to the frame 207b whereas the opposite free edge is positioned upstream in the stowed position and towards the engine in the deployed position.

The thrust reversing system 250 also comprises, for each inner door 104, an outer door 105. The outer doors 105 are distributed over the periphery and on the outside of the nacelle 102 as a function of the angular aperture of the window 210 about the longitudinal axis X. The outer doors 105 are arranged outside relative to the inner doors 104. Each outer door 105 is mounted facing an inner door 104 and the outer door 105 and the facing inner door 104 constitute a pair of doors. The thrust reversing system 250 thus comprises a plurality of pairs of doors 104, 105 arranged inside the nacelle 102.

Each outer door 105 is mounted articulated on the frame 207b between a stowed position (FIGS. 3 and 4) and a deployed position (FIG. 5) and vice versa. The switching from the stowed position to the deployed position is performed by a rotation of the outer door 105 towards the outside of the jet engine 100. The articulations of the outer doors 105 are overall facing the articulations of the inner doors 104, as is shown in FIG. 5, when the inner doors 104 and the outer doors 105 are deployed they form, overall, a continuity.

The stowed position of the outer doors 105 can be adopted when the frame 207b is in advanced position or in retracted position. The deployed position can be adopted only when the frame 207b is in retracted position. The deployed, respectively stowed, position of the outer doors 105 is synchronized with the deployed, respectively stowed, position of the inner doors 104.

In the stowed position, each outer door 105 blocks a zone of the openwork part of the frame 207b when the latter is in advanced position and the same zone of the openwork part of the frame 207b and a zone of the window 210 when the frame 207b is in a retracted position. In the deployed position, the outer door 105 does not block the zone of the window 210 or the openwork part of the frame 207b and extends towards the outside of the nacelle 102 allowing the passage of the secondary flow 208.

Thus, in the stowed position, each outer door 105 is overall in the extension of the mobile cowl 207a and in the deployed position, each outer door 105 is opened outwards and deflects the part of the secondary flow 208 which has previously been deflected by the inner doors 104 through the window 210.

In the stowed position, the outer doors 105 are arranged between the mobile cowl 207a and the fixed structure 206 so as to form an outer wall of the nacelle 102 which is therefore in contact with the air flow which flows around the nacelle 102.

In the advanced position, each outer door 105 is positioned outside of the inner doors 104.

Each outer door 105 is articulated by a downstream edge, relative to the direction of flow, at the downstream part of the frame 207b on hinges 212 fixed to the frame 207b whereas the opposite free edge is positioned towards the upstream direction in the stowed position and towards the outside in the deployed position.

In the embodiment of the invention presented in FIGS. 3 to 5, the hinges 212 of the inner doors 104 and of the outer doors 105 are merged, but they could be staggered.

For each pair of doors 104, 105, the thrust reversing system 250 has a runner 214 associated with the pair of doors 104, 105. The runner 214 is mounted to be translationally mobile in a direction parallel to the direction of translation on the frame 207b. The runner 214 is thus mobile between a first position and a second position.

The switching from the stowed position to the deployed position of each door 104, 105 of the pair is mechanically associated with the switching of the runner 214 from the first position to the second position and vice versa.

In the particular embodiment presented here, the thrust reversing system 250 also has, for each runner 214, a first transmission system 216 which, for the inner door 104 associated with the runner 214, here takes the form of a rod articulated by one end to the inner door 104 and articulated by another end to the runner 214.

In the same way, the thrust reversing system 250 also has, for the runner 214, a second transmission system 217 which, for the outer door 105 associated with the runner 214, here takes the form of a rod articulated by one end to the outer door 105 and articulated by another end to the runner 214.

The first transmission system 216 is provided to switch the inner door 104 associated with the runner 214 from the stowed position to the deployed position simultaneously with the switching of the runner 214 from the first position to the second position in order to open the inner door 104 and vice versa.

The second transmission system 217 is provided to switch the outer door 105 associated with the runner 214 from the stowed position to the deployed position simultaneously with the switching of the runner 214 from the first position to the second position in order to open the outer door 105 and vice versa.

In the embodiment of the invention presented here, the first position comprises displacing the runner 214 forwards whereas the second position comprises displacing the runner 214 backwards.

The translation of the runner 214 is produced by guide systems between the frame 207b and the runner 214 which can, for example, take the same form of a rail 215 of the frame 207b.

The switching from the advanced position of the frame 207b to the retracted position of the frame 207b and the deployed position of the inner doors 104 and of the outer doors 105 comprises therefore, from the advanced position of the frame 207b and therefore from the stowed positions of the inner 104 and outer 105 doors, retracting the frame 207b by translation relative to front frame 206 to reach the retracted position for the frame 207b and the stowed positions of the inner 104 and outer 105 doors, then in displacing each runner 214 from the first position to the second position to switch the inner doors 104 and the outer doors 105 from the stowed position to the deployed position.

The reverse displacement makes it possible to revert to the advanced position.

The nacelle 102 also comprises a set of actuators 218 and 220 ensuring the translational displacement of the frame 207b and of the runner 214. Each actuator 218, 220 is controlled by a control unit, for example of the processor type, which controls the displacements in one direction or the other depending on the needs of the aircraft 10.

Each actuator 218, 220 can for example take the form of an electric ball jack or any other appropriate types of jacks.

To ensure the displacement of the frame 207b, the nacelle 102 comprises at least one first actuator 218 of which there are three here, and which are fixed between the fixed structure 206 of the nacelle 102, and the frame 207b. Each first actuator 218 is thus provided to ensure, from the advanced position of the frame 207b and therefore from the stowed positions of the inner 104 and outer 105 doors, a translational displacement of the frame 207b to the retracted position, and vice versa. During the displacement of the frame 207b, each runner 214 which is borne by the frame 207b follows the same displacement.

To ensure the displacement of each runner 214, and therefore of each inner 104 and outer 105 door, the thrust reversing system 250 comprises, for each runner 214, a second actuator 220 which is fixed between the frame 207b and the runner 214. The second actuator 220 is provided to ensure the translational displacement of the runner 214 from the first position to the second position.

The second actuator 220 is distinct from each first actuator 218 and they can therefore be displaced independently of one another. The displacement of the mobile assembly 207 from the advanced position to the retracted position is disassociated from the displacement of the doors 104 and 105.

FIG. 7 shows a functional diagram of a displacement method 700 for the thrust reversing system 250 which comprises, from the advanced position of the mobile assembly 207, from the stowed positions of the inner 104 and outer 105 doors, from the first position of the runners 214:
a first activation step 702 during which each first actuator 218 is activated to ensure the translational displacement of the mobile assembly 207 and therefore of the frame 207b from the advanced position to the retracted position, then
a second activation step 704 during which each second actuator 220 is activated to ensure the translational displacement of the associated runner 214 from the first position to the second position, then
a third activation step 706 during which each second actuator 220 is activated to ensure the translational displacement of the associated runner 214 from the second position to the first position, then
a fourth activation step 708 during which each first actuator 218 is activated to ensure the translational displacement of the mobile assembly 207 and therefore of the frame 207b from the retracted position to the advanced position.

The invention has been more particularly described in the case of a nacelle under a wing but it can be applied to a nacelle situated at the rear of the fuselage.

In order to better control the secondary flow 208, the nacelle 102 comprises at least one baffle plate 226 (if there are several thereof, it is then a cascade-type gate) which is arranged around the secondary jet 202 at the entry of the window 210, that is to say, overall, at the zone of transition from the secondary jet 202 to the window 210 in a zone where the flow has the greatest difficulty in turning to create reverse thrust (that is to say forward of the nacelle).

Each baffle plate 226 is fixed to the fixed structure 206 of the nacelle 102, and it is fixed here for example to the fan casing 206a. Each baffle plate 226 takes the form of an aileron which orients the secondary flow 208 towards the window 210 then towards the front of the dual flow jet engine 100. In the embodiment of the invention presented here, the mobile cowl 207a comprises an inner wall oriented towards the secondary jet 202 and an outer wall oriented towards the outside of the nacelle 102, and in position of closure, each baffle plate 226 is housed in the mobile assembly 207, that is to say, between the inner wall and the outer wall.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A dual flow jet engine comprising
an engine,
a nacelle surrounding the engine and
a fan casing, in which a secondary jet of a secondary flow is delimited between the nacelle and the engine and in which an air flow circulates in a direction of flow,
the nacelle comprising:
a fixed structure attached to the fan casing,
a thrust reversing system having:
a mobile assembly having a mobile cowl and a frame, the mobile cowl being fixed to and downstream of the frame relative to the direction of flow, the mobile assembly being translationally mobile on the fixed structure in a direction of translation between an advanced position in which the mobile assembly is positioned such that the mobile cowl is close to the fan casing and a retracted position in which the mobile assembly is positioned such that the mobile cowl is at a distance from the fan casing to define between them an open window between the secondary jet and the outside of the nacelle,
a plurality of pairs of doors arranged inside the nacelle, each pair being formed by an inner door and an outer door arranged facing the inner door, each door being mounted articulated by a downstream edge, relative to the direction of flow, on the frame between a stowed position in which it blocks a zone of the window and a deployed position in which it does not block the zone of the window, the inner doors extending towards the engine in the deployed position, the outer doors extending outwards from the nacelle in the deployed position and being arranged between the mobile cowl and the fixed structure in the stowed position so as to form an outer wall of the nacelle,
for each pair of doors, a runner associated with the pair of doors, the runner being mounted to be translationally mobile parallel to the direction of translation on the frame between a first position and a second position, in which the switching from the stowed position to the deployed position of each door of the pair is mechanically associated with the switching of the runner from the first position to the second position, and vice versa, and
for each runner, a second actuator provided to ensure a translational displacement of the runner from the first position to the second position and vice versa, and
at least one first actuator provided to ensure the translational displacement of the frame from the advanced position to the retracted position and vice versa.

2. The dual flow jet engine according to claim 1, wherein the thrust reversing system further comprises, for each runner,
a first transmission system provided to switch the inner door associated with said runner, from the stowed position to the deployed position simultaneously with the switching of the runner from the first position to the second position and vice versa, and, for each runner,
a second transmission system provided to switch the outer door associated with said runner, from the stowed position to the deployed position simultaneously with the switching of the runner from the first position to the second position and vice versa.

3. The dual flow jet engine according to claim 2, wherein each actuator takes the form of an electric ball jack.

4. The dual flow jet engine according to claim 1, wherein the nacelle comprises at least one baffle plate arranged around the secondary jet at an entry of the window.

5. An aircraft comprising at least one dual flow jet engine according to claim 1.

6. A displacement method for a thrust reversing system according to claim 1 and comprising, from the advanced position of the mobile assembly, from the stowed positions of the inner and outer doors, from the first position of the runners:
a first activation step during which each first actuator is activated to ensure the translational displacement of the mobile assembly from the advanced position to the retracted position, then
a second activation step during which each second actuator is activated to ensure the translational displacement of the associated runner from the first position to the second position, then
a third activation step during which each second actuator is activated to ensure the translational displacement of the associated runner from the second position to the first position, then
a fourth activation step during which each first actuator is activated to ensure the translational displacement of the mobile assembly from the retracted position to the advanced position.
